(19) United States
(12) Patent Application Publication
(10) Pub. No.: US 2005/0074052 A1
(43) Pub. Date: Apr. 7, 2005

(54) Method and apparatus for generating noise-added signal

(76) Inventor: Susumu Akada, Kanagawa (JP)

Correspondence Address: FISH & RICHARDSON P.C., 1425 K STREET, N.W., 11TH FLOOR, WASHINGTON, DC, 20005-3500, US

(21) Appl. No.: 10/948,541

(22) Filed: Sep. 24, 2004

(30) Foreign Application Priority Data
Oct. 6, 2003 (JP) 346846/2003

(51) Int. Cl. H04B 1/69

(52) U.S. Cl. 375/130

(57) ABSTRACT

A signal generator is provided for adding noise to a signal to generate a noise-added signal. The signal generator comprises a PN coder in a noise generator which generates noise that is added to a signal. The noise generator uses a PN code from the PN coder to generate pseudo white noise at least in a predetermined band. A noise adder adds the noise from the noise generator to a signal from a signal source to generate the noise-added signal.

### BACKGROUND OF THE INVENTION

The present invention relates to the generation of signals, and more particularly, to a method and apparatus for generating a signal to which noise is added in order to provide a carrier-to-noise ratio (C/N ratio) and the like.

In integrated services digital broadcasting-terrestrial (ISDB-T) systems, there is a method known for providing a C/N ratio specified for an orthogonal frequency division multiplexed (OFDM) signal to be broadcast, which enables a C/N-to-BER (carrier-to-noise to bit-error-rate) characteristic to be measured. To provide such a C/N ratio, there is employed in a C/N generator circuit a delay circuit for delaying each of symbols in OFDM data; or there is employed ROMs in which appropriate OFDM data symbols are pre-stored to generate pseudorandom noise data, which is added to the OFDM data (see, for example, Japanese Patent Application Public-Disclosure No. 11-284598).

Another C/N controller comprises a plurality of noise memories (ROMs), and an address controller for adding a plurality of M-series to generate a white Gauss noise series (see Anritsu Technical No. 80, January 2002).

### SUMMARY OF THE INVENTION

According to one aspect of the invention, a signal generating method is provided for generating a noise-added signal. The method includes the steps of using a pseudorandom noise (PN) code to generate pseudo white noise in at least a predetermined band, and adding the noise to a received signal to generate a noise-added signal. The signal generating method further includes generating the received signal.

According to further aspect of the present invention, the PN code may be used in spectrum spreading which does not involve spectrum despreading. The signal and the noise may be in a digital form. The signal may include a carrier. The step of generating noise may include generating the noise to be added to the signal to provide a predetermined ratio. The predetermined ratio may define a predetermined C/N ratio. The carrier may comprise an OFDM signal.

According to another aspect of the present invention, a signal generator apparatus is provided which includes a noise generator having a PN coder such that the noise generator uses a PN code from the PN coder to generate pseudo white noise in at least a predetermined band, and a noise adder that receives a signal and the noise from the noise generator to add the noise to the signal to generate a noise-added signal. The signal generator apparatus may further include a signal source that generates the signal.

According to further aspect of the present invention, the noise generator may include gain circuitry that increases or decreases in magnitude the noise such that the noise is added to the signal at a predetermined ratio. The gain circuitry may include a gain coefficient setting circuit that generates a predetermined gain coefficient, and a multiplier that multiplies the PN code by the gain coefficient. The predetermined ratio may define a predetermined C/N ratio. The carrier may comprise an OFDM signal. The noise may be used to provide a C/N ratio.

According to the present invention, since the PN code used to generate white noise can be generated by an analog circuit or a simple circuit which does not use ROMs, the overall signal generator apparatus can be implemented at a relatively low cost. Moreover, when the present invention is used in combination with an existing system which has a PN coder, the PN coder of the signal generator apparatus itself can be eliminated by using a PN code from the PN coder of the existing system, thereby further simplifying the circuit configuration.

These and other objects and advantages of the present invention will become more apparent from the following description of the illustrative embodiments.

### BRIEF DESCRIPTION OF THE DRAWINGS

FIG. 1 is a block diagram illustrating a basic configuration of a signal generator according to the present invention;

FIG. 2 is a block diagram illustrating a noise adder circuit which is an embodiment of a noise adder circuit shown in FIG. 1;

FIG. 3 is a block diagram illustrating a C/N generator which utilizes the noise adder circuit of FIG. 2 to provide a C/N ratio according to one embodiment of the present invention;

FIG. 4 is a block diagram illustrating a PN coder which is an example of a PN coder shown in FIG. 3;

FIGS. 5A and 5B show the frequency spectrum and the phase diagram, respectively, of a noise-added OFDM signal output from the C/N generator shown in FIG. 3 when a C/N ratio is added to the OFDM signal;

FIGS. 6A and 6B show the frequency spectrum and the phase diagram, respectively, of a noise-added OFDM signal output from the C/N generator shown in FIG. 3 when a C/N ratio is not added to the OFDM signal;

FIG. 7 is a block diagram illustrating an ISDB-T signal generator/evaluator which utilizes the C/N generator shown in FIG. 3; and

FIG. 8 is a block diagram illustrating an ISDB-T signal generator/evaluator which is a simplified version of the signal generator/evaluator shown in FIG. 7 according to an embodiment of the present invention.

### DETAILED DESCRIPTION OF THE EMBODIMENTS

In the following, the present invention will be described in detail with reference to the accompanying drawings which illustrate a variety of embodiments of the present invention. The disclosure of Japanese Patent application No. 2003-346846 filed Oct. 6, 2003 including specification, drawings and claims is incorporated herein by reference in its entirety.

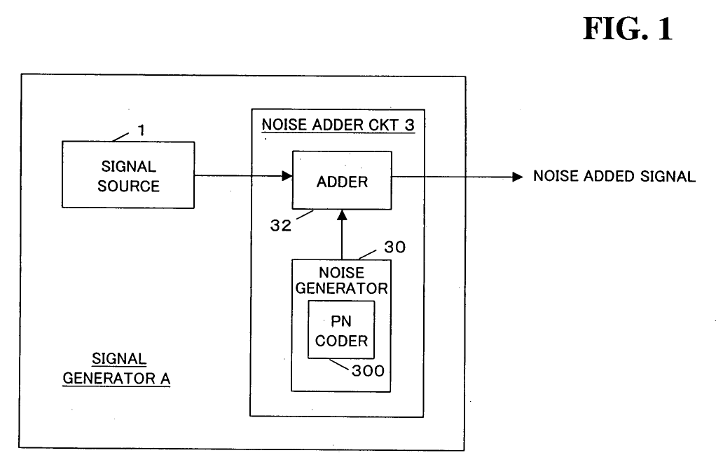

FIG. 1 illustrates in a block diagram form a signal generator A in a basic configuration according to the present invention. As illustrated, the signal generator A comprises a signal source 1 for generating a signal, and a noise adder circuit 3 for adding noise to the signal. Possible signals generated by the signal source 1 at its output may include a modulated signal which is a signal superimposed on a carrier having a higher frequency, and the like, other than baseband signals. The noise adder circuit 3, which receives such a signal at its input, comprises a noise generator 30 and an adder 32. According to the present invention, the noise generator 30 generates white noise virtually, and therefore comprises a pseudorandom noise (PN) coder 300. Here, the PN coder is well known in the field of spread spectrum, and generates a PN code. The adder 32 receives the pseudo white noise formed by PN codes at one input, and adds the pseudo white noise to a signal from the signal source 1 which is received at the other input, to generate a noise-added signal at its output. Here, the adder 32 performs an addition of the type depending on the form, frequency, or the like of received signals. For example, the adder 32 may digitally add signals when it receives digital signals.

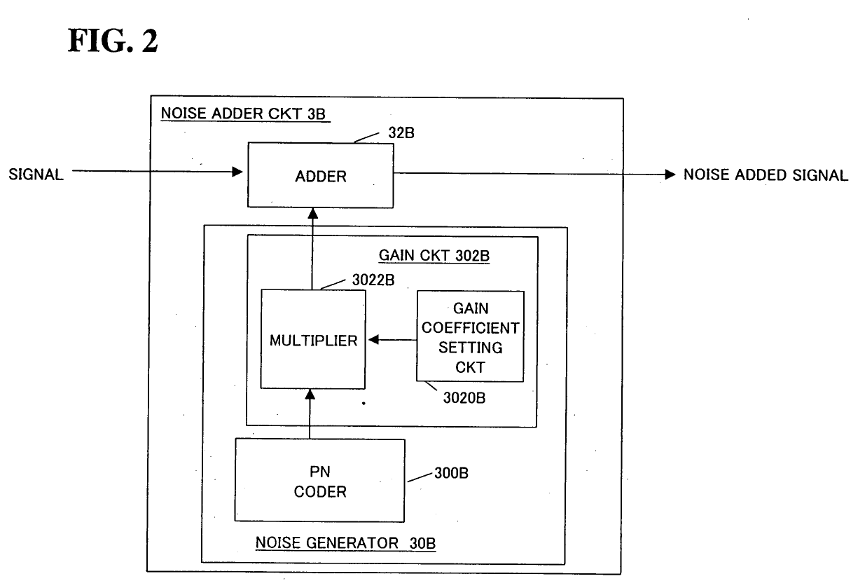

Referring next to FIG. 2, a noise adder circuit 3B, described below, is one embodiment of the noise adder circuit 3 in FIG. 1. In FIG. 2, elements corresponding to those in FIG. 1 are denoted by the same reference numerals with the exception that they have a symbol “B” appended thereto. As illustrated, the noise adder circuit 3B comprises a noise generator 30B and an adder 32B. The noise adder circuit 3B adds noise to a signal at a specified ratio. For carrying out this operation, the noise generator 30B comprises a gain circuit 302B in addition to a PN coder 300B. The gain circuit 302B comprises a gain coefficient setting circuit 3020B, and a multiplier 3022B. The setting circuit 3020B sets a gain coefficient corresponding to a specified ratio in order to generate noise of a magnitude that will provide the specified ratio. The setting circuit 3020B may be implemented, for example, by an arbitrary switching means (for example, an ON/OFF switch) which can be manually set by the user, or an arbitrary means (for example, a register) which stores specified gain coefficients. The multiplier 3022B receives a gain coefficient from the setting circuit 3020B at one input, receives PN codes, which make up pseudo white noise, from the PN coder 300B at the other input, and multiplies the gain coefficient by the PN codes to generate at its output the PN codes which have noise, a magnitude of which is increased or decreased by the gain coefficient. The adder 32B, which receives the noise output from the multiplier 3022B at one input terminal, adds the noise to a signal received at the other input terminal to generate the aforementioned noise-added signal at its output. With the foregoing configuration, the ratio at which the noise is added to the input signal can be arbitrarily increased or decreased by the gain coefficient setting circuit 3020B which scales up or down the gain coefficient.

According to the present invention described above, a specified amount of noise can be added to a given signal which is supplied to an electric or electronic device or another arbitrary device under evaluation through a wireless or a wired transmission path (including a simple connection), thereby permitting evaluation of performance of the device. In general communications, a transmitter uses a PN code for spread spectrum of a signal; while a receiver uses a PN code common to that used by the transmitter for decoding the spread-spectrum signal received thereby, i.e., for despreading the received signal. The PN code acts as virtual white noise for a receiver which cannot utilize the common PN code. The present invention takes advantage of this action to supply a receiver not only with a signal but also with pseudo white noise through spread-spectrum of the signal with the PN code, such that the receiver processes the signal without corresponding despreading. According to the present invention, the ability to actively adding the pseudo white nose can be utilized for evaluating a variety of characteristics and performance of electric or electronic devices (for example, an ISDB-T television tuner).

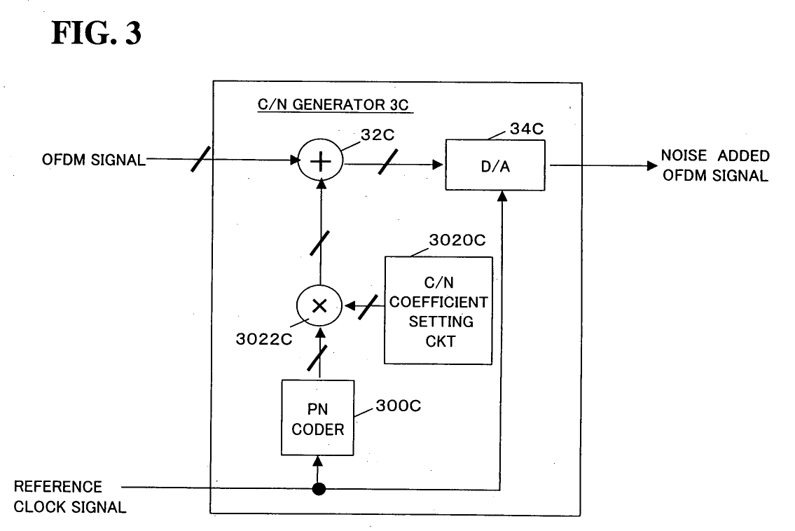

Referring next to FIG. 3, a C/N generator 3C according to one embodiment utilizes the noise adder circuit 3B shown in FIG. 2 for providing a C/N ratio. Likewise, elements in FIG. 3 corresponding to those in FIGS. 1 and 2 are denoted by the same reference numerals, with a symbol “C” appended thereto. As illustrated, the C/N generator 3C adds noise to an orthogonal frequency division multiplexed (OFDM) signal received at an input thereof such that the signal has a specified C/N ratio. Here, the OFDM signal, which is utilized in the integrated services digital television broadcasting ISDB-T, is a modulated signal having signals superimposed on multiple carriers at different frequencies, and is, for example, 16-bit parallel digital data.

The C/N generator 3C, which receives the OFDM signal, comprises a PN coder 300C, a C/N coefficient setting circuit 3020C, a multiplier 3022C, an adder 32C, and a D/A converter 34C, as illustrated. The PN coder 300C, which may be an arbitrary PN coder in a known configuration, receives at its input, for example, a reference clock signal having an over-sampling frequency of 32.507936 MHz, which is four times as high as the IFFT sampling frequency for use with the orthogonal frequency division multiplexing in the integrated services digital television broadcasting, and generates PN code noise data with the same period as the reference clock signal. The PN code noise data may be, for example, 16-bit parallel data which is supplied to one input of the multiplier 3022C. The C/N coefficient setting circuit 3020C, which is one embodiment of the gain coefficient setting circuit 3020B shown in FIG. 2, may be implemented by switching circuitry for setting a C/N coefficient. The C/N coefficient setting circuit 3020C generates, for example, 16-bit parallel coefficient data at its output, and supplies the generated coefficient data to the other input of the multiplier 3022C. The multiplier 3022C multiplies the PN code data by the C/N coefficient data to generate pseudo white noise, i.e., noise data for addition of a C/N ratio which has such a magnitude that provides a specified C/N ratio for the OFDM signal. The adder 32C adds the OFDM signal and noise data for addition of a C/N ratio, received at its respective inputs, to generate a C/N added OFDM signal. The resulting OFDM signal is also a 16-bit parallel digital signal. The subsequent D/A converter 34C, which operates based on the reference clock signal, converts the C/N added OFDM signal from a digital form to an analog form suitable for circuits used in subsequent stages.

In the circuit illustrated in FIG. 3, since the PN coder 300C, C/N coefficient setting circuit 3020C, multiplier 3022C, and adder 32C can be fully made up of digital circuits, these circuits can be implemented by a combination of a PN code algorithm and a field programmable gate array (FPGA).

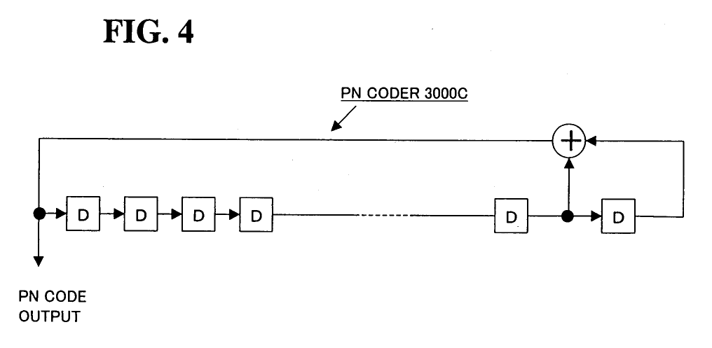

FIG. 4 is a block diagram illustrating a PN coder 3000C which is an example of the PN coder 300C shown in FIG. 3. As illustrated, the PN coder 3000C comprises 23 shift registers (D) connected in series, and an exclusive OR gate which has two inputs connected between the input and output of the right-most shift register. The output of the gate is connected to the input of the left-most shift register, and serves as a serial output terminal of the PN coder. The PN coder 3000c generates from the output terminal a serial PN code output of a “PN23” coder having an order number of 23 (the 16-bit parallel data is transformed from serial PN codes by the outputs of the 16 shift registers). The PN coder illustrated in FIG. 4 is simply an example, and may have another circuit configuration in accordance with particular specifications. A frequency band of white nose which can be generated by the PN coder depends on the clock frequency, the length of registers, and the like.

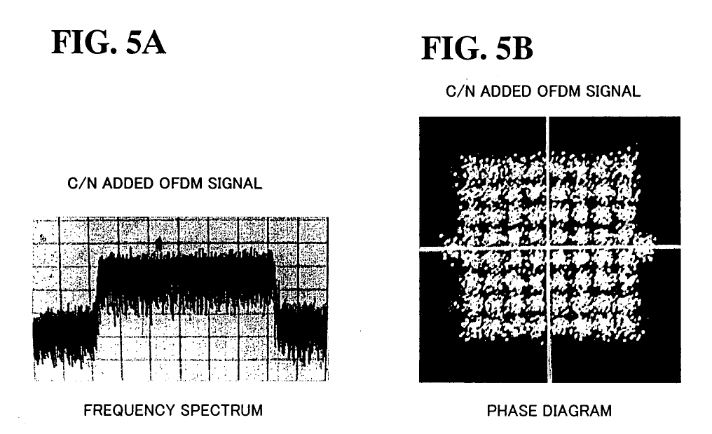

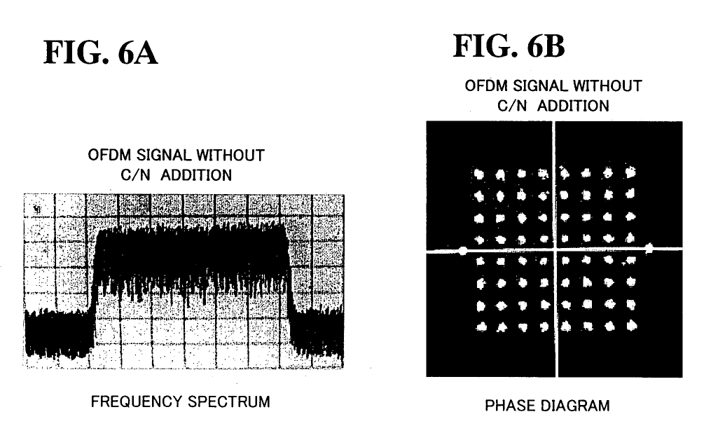

FIGS. 5A and 5B and 6A and 6B show graphs of the frequency spectrum and phase for noise-added OFDM signals output from the C/N generator 3C. FIGS. 5A and 5B show an OFDM signal which has added noise, i.e., an added C/N coefficient (the resulting C/N ratio is 25 dB), while FIGS. 6A and 6B show an OFDM signal which has no added noise, i.e., no added C/N coefficient (the C/N ratio remains at 30 dB). In the frequency spectrum diagrams, the horizontal axis is marked in 1 MHz increments, while the vertical axis is marked in 10 dB increments. As can be seen from a comparison of these graphs, the OFDM signal with the added C/N ratio shown in FIGS. 5A and 5B includes added amplitude noise and phase noise, as compared with the OFDM signal without added C/N ratio shown in FIGS. 6A and 6B, as is apparent from their phase diagrams. In addition, it is confirmed from the constellation in the phase diagram of FIG. 5B that random noise, i.e., white noise is added to the OFDM signal. Thus, according to the present invention, white noise can be generated in at least the frequency band of OFDM signals.

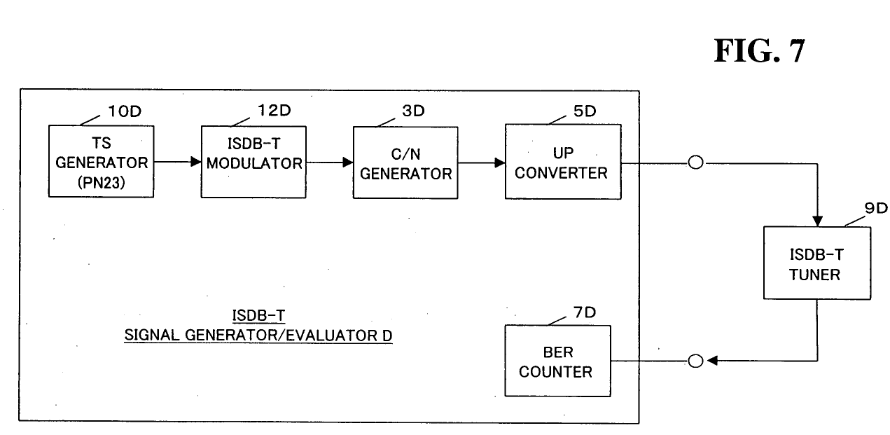

Referring next to FIG. 7, an ISDB-T signal generator/evaluator D utilizes the C/N generator illustrated in FIG. 3 to evaluate the performance of an ISDB-T tuner. The generator/evaluator D is used to measure the C/N-to-BER characteristic of an ISDB-T tuner 9D under evaluation. More specifically, the generator/evaluator D comprises a transport stream (TS) generator 10D (including a “PN23” coder); an ISDB-T modulator 12D; a C/N generator 3D corresponding to the generator shown in FIG. 3; an up-converter 5D; and a BER (bit error rate) counter 7D. The output of the up-converter 5D is connected to the output terminal of the ISDB-T signal generator/evaluator D, to which is connected an input terminal of the tuner 9D under evaluation, which has an output terminal connected to an input terminal of the generator/evaluator D connected to an input terminal of the BER counter 7D.

In the ISDB-T signal generator/evaluator D shown in FIG. 7, a transport stream generated by the TS generator 10D is used to modulate a multiplicity of predetermined carriers in the modulator 12D, and a specified C/N ratio is applied in the C/N generator 3D to an OFDM digital signal resulting from the modulation. The OFDM signal applied with the C/N ratio is next up-converted to a higher frequency by the up-converter 5D, and then input to the tuner 9D. Bit errors in an output signal from the tuner 9D corresponding to the input OFDM signal are counted by the BER counter 7D. Here, the BER counter 7D compares the OFDM signal with reference digital data (output of the TS generator 10D) to measure a bit error rate. As is well known in the art, there is a known correlation between the C/N ratio and BER, so that the performance of a tuner can be determined to be good or bad based on whether or not the tuner has such a correlation.

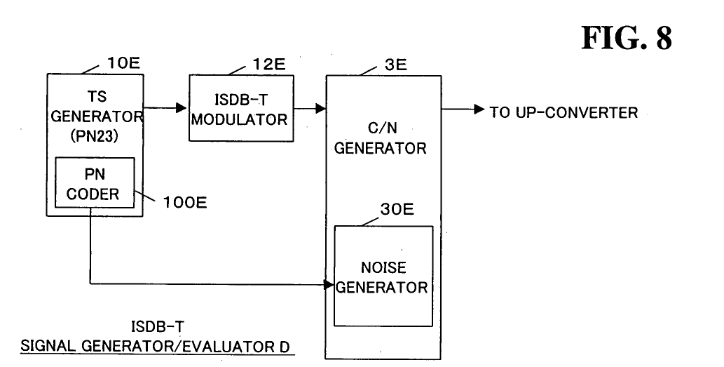

FIG. 8 is a block diagram illustrating an ISDB-T signal generator/evaluator E which is a simplified version of the generator/evaluator D shown in FIG. 7 according to one embodiment. It should be noted that FIG. 8 illustrates only different components from those in FIG. 7, with the remaining components being omitted from the illustration. As can be seen in the embodiment of FIG. 8, the “PN23” PN coder generally included in the TS generator 10E is connected such that its output is supplied to a noise generator 30E in a C/N generator 3E. Specifically, the TS generator 10E comprises a “PN23” PN coder 100E for spread spectrum of a transport stream. In the embodiment of FIG. 8, the PN code output of the PN coder 100E may be used in the noise generator 30E to remove the PN coder in the noise generator 30E. Even if the same output from the PN coder is used in a different component within the generator/evaluator, no problem arises because it is used at a temporally shifted position from a viewpoint of signal processing.

The following modifications can be made to a variety of embodiments of the present invention described above. First, while the foregoing embodiments have been described in detail in connection with the C/N ratio which is given as an example of the ratio, the present invention is not limited to the C/N ratio, but can be used in other applications in which it is necessary to add noise. Further, the signal generator according to the present invention can also be used for measuring other arbitrary operation/processing (for example, the C/N-to-BER characteristic) other than the aforementioned tuning operation of a tuner.

Although only some exemplary embodiments of the invention have been illustrated and described in detail above, those skilled in the art will readily appreciate that the invention is not limited to the precise construction and compositions disclosed herein and that various modifications, changes and variations are possible in the exemplary embodiments without departing from the novel teaching and advantages of the invention. Accordingly, all such modifications are intended to be included within the spirit and scope of the invention.

1. A signal generating method for generating a noise-added signal, comprising the steps of:
using a PN code to generate pseudo white noise in at least a predetermined band; and
adding said noise to a received signal to generate a noise-added signal.

2. A signal generating method according to claim 1, further comprising generating said received signal.

3. A signal generating method according to claim 1, wherein said PN code is used in spectrum spreading which does not involve spectrum despreading.

4. A signal generating method according to claim 1, wherein said received signal and said noise are in a digital form.

5. A signal generating method according to claim 1, wherein said received signal includes a carrier.

6. A signal generating method according to claim 1, wherein said step of generating noise includes generating said noise such that said noise is added to said signal at a predetermined ratio.

7. A signal generating method according to claim 6, wherein said predetermined ratio defines a predetermined C/N ratio.

8. A signal generating method according to claim 1, wherein said carrier comprises an OFDM signal.

9. A signal generator apparatus, comprising:
a noise generator having a PN coder, said noise generator using a PN code from said PN coder to generate pseudo white nose in at least a predetermined band; and
a noise adder that receives a signal and said noise from said noise generator to add said noise to said signal to generate a noise-added signal.

10. A signal generating apparatus according to claim 9, further comprising a signal source for generating said signal.

11. A signal generator apparatus according to claim 9, wherein said noise generator includes:
gain circuitry that increases or decreases in magnitude said noise such that said noise is added to said signal at a predetermined ratio.

12. A signal generator apparatus according to claim 11, wherein said gain circuitry includes:
a gain coefficient setting circuit that generates a predetermined gain coefficient; and
a multiplier that multiplies said PN code by said gain coefficient.

13. A signal generating apparatus according to claim 11, wherein said predetermined ratio defines a predetermined C/N ratio.

14. A signal generating apparatus according to claim 9, wherein said carrier comprises an OFDM signal.

15. A signal generator apparatus according to claim 9, wherein said noise is used to provide a C/N ratio.

16. A C/N generator apparatus comprising:
a noise generator that generates noise to be added to a received carrier, said noise generator using a PN code to generate said noise; and
a noise adder that adds said noise to said carrier to generate a carrier having a predetermined C/N ratio.

17. A C/N generator apparatus according to claim 16, wherein said noise generator includes a PN coder that generates said PN code.

18. A C/N generator apparatus according to claim 16, wherein said noise generator further includes gain circuitry that increases or decreases in magnitude said PN code from said PN coder.

19. A C/N generator apparatus according to claim 18, wherein said gain circuitry includes:
a C/N coefficient setting circuit that generates a C/N coefficient corresponding to said predetermined C/N ratio; and
a multiplier that multiplies said PN code by said C/N coefficient.

20. A C/N generator apparatus according to claim 16, wherein said carrier comprises an OFDM signal.

21. A signal generator apparatus, comprising:
means for generating pseudo white nose in at least a predetermined band using a PN code; and
means for adding said noise to a signal to generate a noise-added signal.
